(19) United States
(12) Patent Application Publication
(10) Pub. No.: US 2025/0294298 A1
(43) Pub. Date: Sep. 18, 2025

(54) HEARING AID SYSTEM AND A METHOD OF OPERATING A HEARING AID SYSTEM

(71) Applicant: Widex A/S, Lynge (DK)

(72) Inventors: Thomas Bo ELMEDYB, Lynge (DK); Lars Dalskov MOSGAARD, Lynge (DK); David PELEGRIN-GARCIA, Lynge (DK); Craig MITCHELL, Lynge (DK); Esteban José Fuentes HENRIQUEZ, Lynge (DK); Ole HAU, Lynge (DK)

(73) Assignee: Widex A/S, Lynge (DK)

(21) Appl. No.: 19/225,064

(22) Filed: Jun. 2, 2025

Related U.S. Application Data
(63) Continuation-in-part of application No. PCT/EP2023/083493, filed on Nov. 29, 2023.

(30) Foreign Application Priority Data
Dec. 2, 2022 (DK) PA202201092

(51) Int. Cl. H04R 25/00

(52) U.S. Cl. CPC H04R 25/453

(57) ABSTRACT

A hearing aid system (200) with improved adaptive feedback suppression and a method (300) of operating such a hearing aid system.

### CROSS-REFERENCE TO RELATED APPLICATIONS

This is a Continuation-in-part of International Application No. PCT/EP2023/083493 filed Nov. 29, 2023, claiming priority based on Danish Patent Application No. PA202201092 filed Dec. 2, 2022.

### FIELD OF THE INVENTION

The present invention relates to hearing aid systems. The invention more particularly relates to hearing aid systems that rely on adaptive feedback cancellation in order to reduce the problems caused by acoustic feedback. The invention also relates to methods of operating hearing aid systems.

### BACKGROUND OF THE INVENTION

Within the context of the present disclosure a hearing aid can be understood as a small, battery-powered, microelectronic device designed to be worn behind or in the human ear by a hearing-impaired user. Prior to use, the hearing aid is adjusted by a hearing aid fitter according to a prescription. The prescription is based on a hearing test, resulting in a so-called audiogram, of the performance of the hearing-impaired user's unaided hearing. The prescription is developed to reach a setting where the hearing aid will alleviate a hearing loss by amplifying sound at frequencies in those parts of the audible frequency range where the user suffers a hearing deficit. A hearing aid comprises one or more microphones, a battery, a microelectronic circuit comprising a signal processor adapted to provide amplification in those parts of the audible frequency range where the user suffers a hearing deficit, and an acoustic output transducer. The signal processor is preferably a digital signal processor. The hearing aid is enclosed in a casing suitable for fitting behind or in a human ear.

Within the present context a hearing aid system may comprise a single hearing aid (a so called monaural hearing aid system) or comprise two hearing aids, one for each ear of the hearing aid user (a so called binaural hearing aid system). Furthermore, the hearing aid system may comprise an external device, such as a smart phone having software applications adapted to interact with other devices of the hearing aid system. Thus within the present context the term “hearing aid system device” may denote a hearing aid or an external device.

Generally a hearing aid system according to the invention is understood as meaning any system which provides an output signal that can be perceived as an acoustic signal by a user or contributes to providing such an output signal and which has means which are used to compensate for an individual hearing loss of the user or contribute to compensating for the hearing loss of the user. These systems may comprise hearing aids which can be worn on the body or on the head, in particular on or in the ear, and can be fully or partially implanted. However, some devices whose main aim is not to compensate for a hearing loss may nevertheless be considered a hearing aid system, for example consumer electronic devices (such as headsets) provided they have some measures for at least partly alleviating an individual hearing loss.

Acoustic feedback from a receiver to one or more microphones will limit the maximum amplification that can be applied in a hearing aid. Due to the feedback, the amplification in the hearing aid can cause resonances, which shape the spectrum of the output of the hearing aid in undesired ways and even worse, it can cause the hearing aid to become unstable, resulting in whistling or howling. The hearing aid usually employs compression to compensate hearing loss; that is, the amplification gain is reduced with increasing sound pressures. Moreover, an automatic gain control is commonly used on the output to limit the output level, thereby avoiding clipping of the signal. In case of instability, these compression effects will eventually make the system marginally stable, thus producing a howl or whistle of nearly constant sound level.

Feedback suppression is often used in hearing aids to compensate the acoustic feedback. The acoustic feedback path can change dramatically over time as a consequence of, for example, amount of earwax, the user wearing a hat or holding a telephone to the ear or the user is chewing or yawning. For this reason, it is customary to apply an adaptation mechanism on the feedback suppression to account for the time-variations.

One widely used method for feedback suppression in hearing aid systems is based on adaptive feedback cancellation. Reference is therefore first given to FIG. 1 which illustrates highly schematically a hearing aid 100, according to the prior art, comprising means for adaptive feedback cancellation.

The hearing aid 100 comprises at least one acoustical-electrical input transducer 101 providing an input signal 106 (which in the following may also be denoted microphone signal y(n)), a digital signal processor 102 (which in the following may also be denoted hearing aid processor) providing an output signal 111 (which in the following may also be denoted loudspeaker signal u(n)), an electrical-acoustical output transducer 103, an adaptive feedback filter 104 and an adaptive feedback estimator 105.

Acoustic feedback occurs when part of the loudspeaker signal is picked up by a microphone creating an acoustic closed loop. A closed loop system becomes unstable when a magnitude of a signal traveling around the loop does not decrease for each round trip, and the feedback signal adds up in phase with a microphone signal. Hence, feedback limits the maximum stable gain achievable, it deteriorates the sound quality by producing a distortion of an incoming signal and can cause howling when the system becomes unstable.

Feedback problems can be reduced by adaptive feedback cancellation techniques that attempt to model a feedback path response h(n) using the adaptive feedback estimator 105 and the adaptive feedback filter 104 and subtract a modeled feedback signal \hat{v}(n) (which in the following may be denoted feedback cancellation signal 109) provided by the adaptive feedback filter 104 from the microphone signal 106 (y(n)).

In FIG. 1, the adaptive feedback filter 104 provides an estimate ĥ(n) of the true acoustic feedback path response h(n). Ideally, ĥ(n)=h(n) and the feedback cancellation signal 109 (\hat{v}(n)) will hereby be identical to the true feedback signal 108 (v(n)). This implies that a residual signal 110 (e(n)) after subtraction of the feedback cancellation signal 109 (\hat{v}(n)) from the microphone signal 106 (y(n)) will only contain the incoming signal 107 (x(n)) without feedback, i.e. e(n)=x(n).

However, a general issue with adaptive feedback cancellation methods for acoustic feedback suppression is that the adaptation generally will not converge towards the optimum suppression of the acoustic feedback due to the biased estimation of ĥ(n).

It can be shown that the bias is given by a cross correlation vector E [u(n)x(n)] between the output signal 111 (u(n)) and the incoming signal 107 (x(n)). Hence, correlation between the output signal 111 and the incoming signal 107 biases the estimation of ĥ(n), and thereby leads to a reduced feedback cancellation performance and may cause the cancellation system to fail and howling to occur.

For most audio signals, the correlation, between the incoming signal 107 and the output signal 111, is strong for short hearing aid signal processing delays and becomes weaker with increasing hearing aid signal processing delays.

Different techniques have been proposed to reduce the biased estimation problem.

One known technique applies de-correlation (e.g. pre-whitening techniques) in the adaptive estimation path. Generally, the advantage of carrying out the decorrelation in the adaptive estimation path is that this does not modify the receiver signal, such that no sound quality degradation is introduced due to the decorrelation. However, this is often not sufficient to ensure a good and reliable canceler performance. This is especially the case when the incoming signal is tonal and hence highly correlated or when the hearing aid processing delay is low.

Alternatively (or additionally) the canceling performance can be improved by de-correlating the loudspeaker signal 111 relative to the incoming signal 107, e.g. by means of frequency shifting or phase shifting. However, this comes at the price of added delay to the main signal path and audible artifacts caused especially by the interference between directly transmitted sound (i.e. ambient sound transmitted past the hearing aid and towards the ear drum) and the amplified and frequency shifted sound provided by the hearing aid.

Another Technique for Reducing the Biased Estimation Problem is Based on Adding a Probe Noise Signal to the Main Signal Path.

EP-B1-1742509 describes a hearing aid system comprising a microphone unit adapted to convert said audio input signal to an electric signal, a filter unit adapted to remove a selected frequency band of said electric signal and pass a filtered signal, a synthesizer unit adapted to synthesize said selected frequency band of said electric signal based on said filtered signal thereby generating a synthesized signal, a combiner unit adapted to combine said filtered signal and said synthesized signal thereby generating a combined signal, and an output unit adapted to convert said combined signal to an audio output signal. Thus, this hearing aid system is limited with respect to performance because it requires that an entire frequency band is removed and later replaced by adding a synthesized signal.

Thus, there is still a need to improve the performance of adaptive feedback cancellation systems based on adding probe noise or some other form of synthesized signal especially with respect to obtaining both high performance adaptive feedback cancelling and high sound quality at least partly by avoiding audible artefacts.

It is therefore a feature of the present invention to provide a hearing aid system with improved adaptive feedback cancellation while maintaining high sound quality.

It is another feature of the present invention to provide a method of operating a hearing aid system that provides improved feedback cancellation while maintaining high sound quality.

### SUMMARY OF THE INVENTION

The invention is set out in the appended claims.

### BRIEF DESCRIPTION OF THE DRAWINGS

By way of example, there is shown and described a preferred embodiment of this invention. As will be realized, the invention is capable of other different embodiments, and its several details are capable of modification in various, obvious aspects all without departing from the invention. Accordingly, the drawings and descriptions will be regarded as illustrative in nature and not as restrictive. In the drawings:

FIG. 1 illustrates highly schematically a hearing aid with adaptive feedback cancellation according to the prior art;

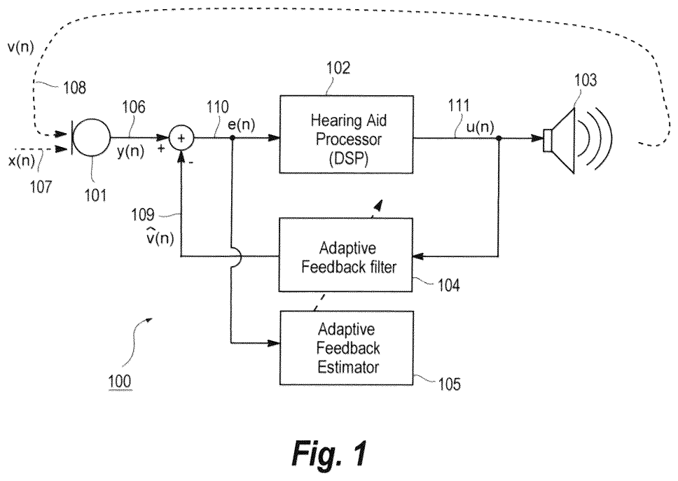

FIG. 2 illustrates highly schematically a hearing aid system according to an embodiment of the invention; and

FIG. 3 illustrates highly schematically a method according to an embodiment of the invention.

### DETAILED DESCRIPTION

In the present context it will generally be considered that the considered parameters/measures are frequency dependent and consequently that the frequency dependency of these parameters/measures will also have been determined unless this is explicitly stated not to be the case. Thus, such frequency dependent measures/parameters comprise e.g. loop gain, feedback path change, tonality, probe noise signal etc.

In the present context at least the terms magnitude, level and value may be used interchangeably unless specifically stated not to be the case. The same is true for the terms tonality measure and tonal components measure.

In the following the abbreviation SQR may also be used to represent the phrase “sound quality reduction” that represents a measure of the sound quality reduction, due to added probe noise and gain attenuation, that is accepted in order to lower the risk of feedback issues, such as feedback howling and sub-oscillations.

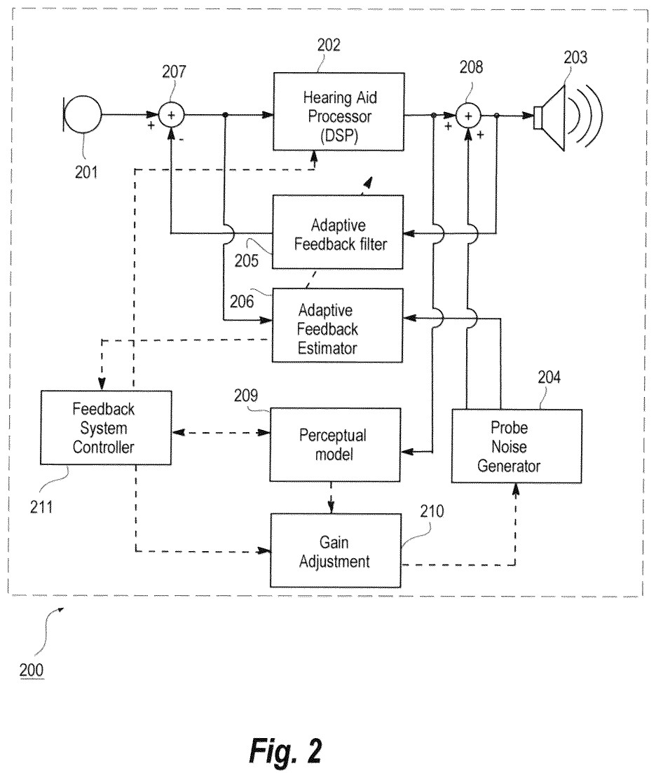

Reference is now made to FIG. 2, which illustrates, highly schematically, a hearing aid system 200 according to an embodiment of the invention. In FIG. 2 the hearing aid system 200 only consists of a single hearing aid, but in a binaural hearing aid system the two hearing aids will obviously have the same elements in order to provide the functionality of the present invention.

The hearing aid system 200 comprises an acoustical-electrical input transducer 201 that receives an audio input signal and converts this audio input signal into an input transducer output signal. The input transducer output signal is fed into a first combiner 207. The first combiner 207 is configured to subtract a feedback cancellation signal from the input transducer output signal and hereby generate a residual signal. The residual signal is branched and provided both to an adaptive feedback estimator 206 and to a digital signal processor (DSP) 202 that generates a processed residual signal. The processed residual signal is also branched and provided both to a second combiner 208 and to a perceptual model 209 (which in the following may also be denoted a masking model generator).

Based on the current processed residual signal, and a control input from the feedback system controller 211, the perceptual model 209 predicts the time and frequency dependent sound levels M(t,f), under which additive noise (i.e. the probe noise signal provided by the probe noise generator 204) is not audible and these sound levels M(t,f) are provided to the gain adjustment unit 210.

The perceptual model 209 additionally provides a measure of the noisiness levels N(t,f) (or alternatively a measure of the tonality) to the feedback system controller 211.

In addition to the sound levels M(t,f) the gain adjustment unit 210 receives from the feedback system controller 211 information of the noise boost factor K_{b}(t,f) that typically represents a purposeful degradation of the resulting sound quality (in at least one frequency range) in order to improve the feedback cancelling performance. Thus normally the noise boost factor K_{b}(t,f) is larger than zero dB and represents the magnitude of the probe noise that is above the masking level.

The probe noise generator 204 adds the probe noise signal to the processed residual signal in order to at least decrease a potential correlation between the output transducer input signal and the part of the input transducer output signal without feedback in order to give the adaptive feedback estimator 206 and the adaptive feedback filter 205 the best conditions for adapting to the current acoustical feedback path by reducing bias because the added probe noise breaks the linearity of the feedback loop. This essentially improves the ability to differentiate between external sounds and a feedback component, which is generally known as reducing the bias.

If the gain adjustment unit 210 (controlling the probe noise generator 204) provides that the resulting probe noise signal level from the probe noise generator 204 is above the masking threshold (i.e. the sound levels M(t,f)) for at least one frequency range then the probe noise will generally be perceived as audible and consequently causing a sound quality reduction.

According to a specific embodiment the noise boost factor K_{b}(t,f) is limited to be smaller than 6 dB, whereby it (for most situations) can be avoided that the added probe noise introduces clipping sound artifacts in the hearing aid system output signal.

Furthermore the gain adjustment unit 210 also receives information from the feedback system controller 211 regarding whether partial substitution Kₛ(t,f) in at least one frequency range is carried out by the hearing aid processor 202 in the form of a gain reduction in said at least one frequency range for the residual signal.

According to an embodiment, if a feedback howl is estimated to be imminent a decrease in gain (as determined by Ks(t,f)) is applied to the residual signal.

According to an embodiment the gain reduction (i.e. Kₛ(t,f)) is limited to 6 dB in order to avoid too severe distortion artifacts.

According to a specific embodiment both the partial substitution Kₛ(t,f) and the noise boost factor K_{b}(t,f) is provided to the gain adjustment unit 210 from the feedback system controller 211 whereby it can be ensured that the audibility is preserved, by ensuring that the decrease in gain applied to the residual signal (as determined by Kₛ(t,f)) is compensated by the probe noise signal (as determined by K_{b}(t,f) but with a potential decrease in sound quality because the original signal is partially replaced by noise in at least one frequency range.

The output signal from the second combiner 208 is provided to an electrical-acoustical output transducer 203 that is configured to generate an acoustical output transducer output signal and consequently the output signal from the second combiner may also be denoted output transducer input signal.

Thus, generally audible artifacts can result from using probe noise and from making a frequency dependent reduction of the gain applied to compensate or alleviate a hearing loss (in the following this applied gain may also be denoted hearing aid gain). Caution should therefore preferably be made such that these measures are only used when needed.

However, as already discussed it is advantageous to add a probe noise signal in order to stabilize the hearing aid system and to ensure that the bias in the feedback path estimate is reduced and by reducing the hearing aid gain in at least one frequency range the risk of feedback issues such as feedback howling can likewise be reduced.

However, the inventors have also realized that in some cases it is desirable to add an audible probe noise or make frequency dependent reduction of the hearing aid gain even if an audible artifact will result. One example of such a case is when there is a (relatively) high risk of feedback howling since a howling hearing aid system will generally be much more annoying than any other audible artifacts.

According to more specific embodiments, a high risk of feedback howling may be estimated if at least one of the following criteria are fulfilled: the open loop gain value exceeds an open loop gain threshold value, the feedback margin falls below a feedback margin threshold, and an autocorrelation measure of the input transducer output signal exceeds an autocorrelation threshold.

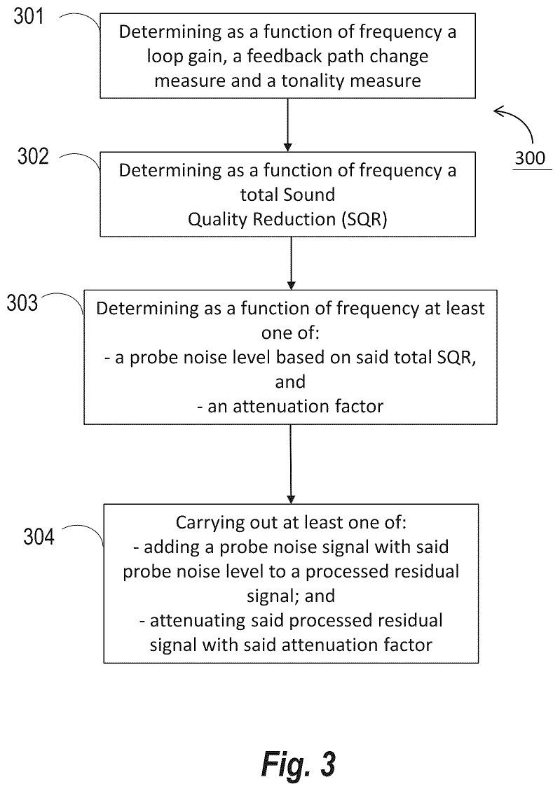

Reference is now made to FIG. 3, which illustrates highly schematically a flow diagram of specific steps of a method 300 of operating a hearing aid system with adaptive feedback cancellation according to an embodiment of the invention. The following steps are carried out by a hearing aid system such as the hearing aid system (200) according to the FIG. 2 embodiment.

Initially, an acoustical input signal is received by an acoustical-electrical input transducer that in response hereto provides an input transducer output signal. Next a feedback cancellation signal is subtracted by a first combiner from the input transducer output signal in order to provide a residual signal and subsequently the residual signal is processed by hearing aid signal processing means in order to generate a processed residual signal adapted to alleviate a hearing loss.

Continuously or at least sometimes probe noise is added to at least one frequency range of the processed residual signal and hereby providing an output transducer input signal with improved decorrelation between the input and output signals of the hearing aid system and consequently also reducing the bias of the adaptive feedback canceller.

Additionally, continuously or at least sometimes the gain applied by the hearing signal processing means is reduced in at least one frequency range in order to reduce the risk of feedback howling.

In a first step 301 of the method according to the present embodiment a loop gain, a feedback path change measure and a measure of tonal components (i.e a tonality measure) are determined.

According to an embodiment the loop gain is determined by first determining the attenuation of the acoustic feedback path, then determining the gain of the hearing aid system from input to output (i.e. the gain applied by the hearing aid system) and finally determining the loop gain as the product of said determined attenuation of the acoustic feedback path and said determined gain of the hearing aid system.

According to an embodiment the measure of feedback path change is determined as a frequency dependent statistical estimate of a drift of at least one adaptive feedback cancellation filter characteristic. This embodiment is especially advantageous because analysis of a filter characteristic of the adaptive feedback filter can enable a faster and more precise tracking of the feedback patch compared to methods based on analysis of the associated signals.

According to a more specific embodiment the measure of feedback path change is determined as the maximum value of a time average of the sign change for both the real part and the imaginary part of a frequency domain adaptive filter coefficient for a plurality of said real and imaginary parts of the frequency domain adaptive filter coefficients k. Thus, this maximum value may be determined as:

$$C {M}_{Max , FD} ( {k}_{0} ) = {max}_{k ∈ \{ {k}_{0} - \frac{Δ k}{2} , {k}_{0} + \frac{Δ k}{2} \}} \{ abs ( {d}_{r e} ( k ) ) , abs ( {d}_{im} ( k ) ) \}$$

wherein k, dᵣₑ(k) and dᵢₘ(k) are given as:

$${d}_{re} ( k ) = \frac{{p}_{re} ( k )}{{m}_{re}} - \frac{{n}_{re} ( k )}{{m}_{re}}$$

wherein k is the frequency domain filter coefficient index and pᵣₑ, nᵣₑ and mᵣₑ are respectively, the number of calculation steps where the value of the real part of the frequency domain filter coefficient is increasing, the number of calculation steps where said value is decreasing and the total number of calculation steps used for determining the time average of the sign change dᵣₑ(k) and given as:

$${d}_{im} ( k ) = \frac{{p}_{im} ( k )}{{m}_{im}} - \frac{{n}_{im} ( k )}{{m}_{im}}$$

wherein k is the frequency domain filter coefficient index and pᵢₘ, nᵢₘ and mᵢₘ are respectively, the number of calculation steps where the value of the imaginary part of the frequency domain filter coefficient is increasing, the number of calculation steps where said value is decreasing and the total number of calculation steps used for determining the time average of the sign change dᵢₘ(k).

It is noted that this frequency domain change measure is advantageous in providing a frequency dependent change measure which e.g. enables de-correlation to be applied only in a limited frequency range, if the feedback path change is limited to this frequency range, whereby undesirable sound artefacts may be avoided.

As will be well known for the skilled person the frequency domain adaptive filter coefficients are determined by a discrete Fourier transforming of the time domain adaptive filter coefficients. Thus, the frequency domain adaptive filter coefficients represent the frequency response of the adaptive filter.

According to an embodiment the measure of tonal components is determined by: first estimating for a plurality of frequency ranges a minimum and a maximum value of signal power for a signal in the main signal path, such as the input signal and then determining the measure of tonal components based on a ratio of the estimated maximum value of the signal power compared to the estimated minimum value of the signal power, wherein the measure of tonal components decreases with the estimated ratio.

Alternatively, the measure of tonal components can be determined by: estimating for a plurality of frequency ranges the signal bandwidth for a signal in the main signal path; and then determining the measure of tonal components based on the determined signal bandwidth and the stability of the signal in the main signal path, wherein the measure of tonal components decreases with the determined bandwidth and increases with the stability if the determined bandwidth is below a given threshold.

In a second step 302, a frequency dependent total sound quality reduction is determined based on said loop gain, feedback path change measure and measure of tonal components.

According to one more specific embodiment, the total sound quality reduction is determined based on a first dynamic sound quality reduction and a first steady-state sound quality reduction, wherein each are based on at least one of said loop gain, measure of feedback path change and measure of tonal components determined as a function of frequency.

More specifically, the first steady-state sound quality reduction is determined as a function of the loop gain, wherein the first steady-state sound quality reduction is monotonically increasing with the loop gain. This reflects that the higher the loop gain is in a particular frequency range the higher the risk of feedback issues and consequently that a higher sound quality reduction is acceptable in this frequency range in order to avoid feedback issues.

The first dynamic sound quality reduction is determined as a function of the measure of feedback path change wherein the first dynamic sound quality reduction is monotonically increasing with the measure of feedback path change.

According to a yet more specific embodiment the first dynamic sound quality reduction increases with increasing loop gain magnitude above a first threshold value.

According to another more specific embodiment, that may be combined with the other specific embodiment given directly above, the first dynamic sound quality reduction is increased in response to an increasing level of the measure of tonal components, which reflects that a high level of tonal components in a given frequency range may be an indication of a potential feedback issue in the form of a howl and consequently that a higher sound quality reduction is acceptable in this frequency range in order to avoid feedback issues.

Thus the two (first) sound quality reductions (SQRs) each represent a compromise between sound quality and feedback canceller performance, in that a high value for either of the two SQRs reflects that some amount of sound quality reduction is acceptable in order to avoid feedback issues, typically in the form of feedback howling.

Generally the total sound quality reduction is determined as a mapping of a combination of a dynamic sound quality reduction and a steady-state sound quality reduction.

According to a specific embodiment the total sound quality reduction is determined as the sum of the first dynamic SQR and the first steady-state SQR. However, according to another specific embodiment the total SQR may be equal to either of the two SQRs.

According to a specific embodiment the total SQR is determined by determining a budget (i.e. an upper limit) for the acceptable sound quality reduction in the present situation.

According to a more specific embodiment a first budget for dynamic SQR is determined together with a second budget for steady-state SQR. Both of these are based on at least one of user preference, identified sound environment, a wireless communication signal and a motion sensor output.

According to a more specific embodiment a budget based on user preference, can be obtained by presenting the user for a plurality of listening situations with different amounts of sound quality reductions and requesting the user to evaluate whether the amount of sound quality reduction is acceptable and based hereon determine a suitable budget. A suitable budget (or budgets) may be determined once (e.g. at the initial fitting of the hearing aid system) or may be determined adaptively based on the users experience when wearing the hearing aid system, e.g. by using the fine tuning algorithm described in EP3167625B1 by the same applicant.

Alternatively, or in combination with the user preference at least one of the first and second budget is based on the identified sound environment e.g. by using a sound classification system that is implemented in many contemporary hearing aid systems.

According to another more specific embodiment at least one of the first and second budget is determined at least partly in response to a trigger action such as receipt of a wireless communication signal and a motion sensor signal from the hearing aid system that e.g. may indicate a tap on the hearing aid system. In both these cases it may be considered to increase the budgets because both cases may indicate that an increased open loop gain—and hereby a higher risk of feedback issues—is imminent. In the former case because the wireless communication signal may be an incoming phone signal that may require the user to manipulate the hearing aid system and hereby increase the risk of feedback. In a similar manner the motion sensor signal may indicate that a user is manipulating the hearing aid system, e.g. by tapping on it.

Thus when the first and second budgets are determined a second dynamic SQR is determined based on the first budget and a second steady-state SQR is determined based on the second budget.

According to a more specific embodiment the second dynamic SQR is determined by allocating (which in the following may be denoted re-distributing) the first budget for dynamic SQR as a function of frequency such that the frequency ranges having the highest values of the first dynamic SQR as a function of frequency are prioritized.

In a similar manner the second steady-state SQR is determined by allocating the second budget for steady-state SQR as a function of frequency such that the frequency ranges having the highest values of the first steady-state sound quality reduction as a function of frequency are prioritized.

This principle can also be described in general terms by the steps of:
1) determining at least one frequency range with a maximum SQR and allocate a number of units, corresponding to the difference between the maximum SQR and the second highest SQR, from the budget to said (at least one) determined frequency range, and reduce in response hereto the SQR value of said (at least one) determined frequency range with said number of units. If the budget is not sufficient the remaining units are distributed equally among the (at least one) frequency range(s) with the maximum SQR.
2) repeat step 1, until all units from the budget have been allocated or until the SQR at all frequencies reaches 0.

It is noted that in case a SQR budget is sufficiently large, then the first and second sound quality reductions will be identical.

According to a third step 303 of the present embodiment a frequency dependent probe noise level and an attenuation factor is determined based on the total SQR.

According to a specific embodiment the probe noise level also depends on the measure of tonal components, such that the probe noise level increases with the total SQR and decreases with the measure of tonal components.

According to a more specific embodiment the probe noise level relative to the masking level is determined as the total SQR divided by the measure of tonal components.

According to an embodiment the masking level is determined using a perceptual model based on a received processed residual signal from the main signal path of the hearing aid system.

According to another specific embodiment the frequency dependent attenuation factor (i.e. Kₛ(t,f)) is determined based on the masking level and the probe noise level.

According to a fourth and final step 304 according to the present embodiment the frequency dependent attenuation factor is applied to the processed residual signal in the main signal path using the hearing aid processor of the hearing aid system, that also applies a frequency dependent gain in order to compensate or alleviate a hearing deficit.

At the same time a probe noise signal with the determined frequency dependent level is added to the processed residual signal.

According to a more specific embodiment the probe noise signal is added to the processed residual signal downstream of the point where the processed residual signal is provided to the perceptual model.

Thus as explained above the present invention is similar to known adaptive feedback canceller (AFC) systems in using probe noise to reduce the bias that leads to not optimal adaptive feedback canceller performance.

However, the present invention offers an extension to known probe noise based adaptive feedback canceller systems, by spectrally manipulating the amplified signal and the probe noise signal in a time-varying fashion and mixing the two together in order to achieve an optimum level with respect to both decorrelation (i.e. reduced bias) and perceptual degradation (i.e. sound quality reduction). This manipulation can be spectrally targeted to one or more frequency ranges (such as frequency ranges defined by frequency bands provided by a filter bank) and have shorter or longer durations.

One specific advantage of the present invention is that the gain applied in order to alleviate a hearing loss can be reduced in at least one frequency range (which may be advantageous or even required in order to avoid feedback howling) without reducing audibility by adding probe noise compensating for the gain reduction. Furthermore, by adding the probe noise in this way the (frequency dependent) ratio between the probe noise and the amplified signal (PNSR) is increased, which enables a more accurate control of the AFC and hereby a high feedback margin while preserving sound quality with respect to feedback canceller induced sound artifacts. However, the overall sound quality may still suffer somewhat because the original sound is replaced by the uncorrelated probe noise.

Thus the higher the PNSR the more accurate the control of the AFC and hereby improved margin before feedback howling occurs.

In summary the present invention provides a flexible trade-off between sound quality and AFC performance by preserving the sound quality whenever possible or limit the audibility of the purposely introduced artifacts.

In other words the present invention distinguishes traditional spectral substitution methods where complete frequency bands (or frequency ranges) are replaced with a known noise signal in that complete substitution is not required and instead various degrees of partial substitution can be carried out and be combined with a probe noise signal of likewise varying magnitude, and wherein both the degree of partial substitution (i.e. reduction of hearing loss gain) and magnitude of probe noise signal can depend on the specific situation.

It is generally noted that even though many features of the present invention are disclosed in embodiments comprising other features then this does not imply that these features by necessity need to be combined.

As one example it is noted that the invention can be implemented based on both time domain and time-frequency domain filterbanks.

According to an embodiment a so called detectability (that in the following is abbreviated D) is used (at least partly) to ensure that a given distortion budget (that in the following is abbreviated B) is not exceeded.

In an embodiment the detectability D is defined as:

$$D = \frac{1}{{N}_{b}} + {\sum }_{b = 1}^{{N}_{b}} \frac{{n ( b )}^{2}}{{m ( b )}^{2}}$$

Wherein n represents a distortion level (such as a probe noise level (in a given frequency band b). Wherein m represents a masking threshold level (also in a given frequency band b) and wherein N_{b} represents the number of considered frequency bands and wherein the considered frequency bands are of equal auditory importance, meaning that the audible frequency spectrum is divided into frequency bands that reflect how the human ear perceives sound in a way that aligns with our perceptual sensitivity. The most important aspects of such frequency band distributions are:
the perceptual uniformity, which ensures that each band is designed to represent a region of the frequency spectrum that contributes equally to auditory perception.
the critical bandwidth, which ensures that the width of each frequency band corresponds to the frequency range within which the human auditory system processes sounds as a single perceptual unit (i.e. the critical bandwidth corresponds to the bandwidth of the auditory filter centered at a given frequency). Furthermore the critical bandwidth is important with respect to masking (i.e. when the presence of one sound (the masker) makes it harder to hear another sound), because if both the masker and the other sound fall within the same critical band, the masking effect is strong because the auditory system cannot easily separate the two sounds, since they are processed by the same auditory filter. On the other hand if said other tone lies outside the critical band of the masker, the masking effect drops off sharply.
the nonlinear frequency scaling, which ensures that the frequency bands are spaced more closely at low frequencies and more widely at high frequencies and hereby reflecting the ear's logarithmic sensitivity.

Examples of frequency band distributions having frequency bands of equal auditory importance includes the Bark scale and the ERB (Equivalent Rectangular Bandwidth) scale.

Thus according to one embodiment the frequency dependent distortion level n is (during normal operation) set to be equal to the frequency dependent masking level m whereby the detectability becomes unity. In the following the frequency dependent distortion level n may also be denoted a custom distortion n′ and when applying such a custom distortion n′ the resulting (i.e. modified) detectability D′ is given by:

$${D}^{′} = \frac{1}{{N}_{b}} + {\sum }_{b = 1}^{{N}_{b}} \frac{{{n}^{′} ( b )}^{2}}{{m ( b )}^{2}}$$

Thus, in case, e.g. the probe noise level exceeds the masking level a sound quality degradation (which is the same as a sound quality reduction) results that is proportional to 10·Log₁₀(D′).

In an embodiment the frequency dependent (which in the following may also be denoted banded) custom distortions n′(b) are given by:

$${{n}^{′} ( b )}^{2} = ( 1 + Δ {D}_{b} ) {m ( b )}^{2}$$

where ΔD_{b} in the following is denoted the normalized target distortion.

According to an embodiment the normalized target distortion is determined for at least one frequency range or frequency band (such as for each frequency band, i.e. the full frequency range) and additionally separate respectively dynamic and steady-state normalized target distortions are determined,
wherein the dynamic normalized target distortion ΔD_{b,Dynamic} is selected to increase with (such as be proportional with) a feedback path change measure CM and
wherein the steady-state normalized target distortion ΔD_{b,SS} is selected to increase with (such as be proportional with) a loop gain (such as the maximum loop gain) LG_{Max}.

According to said same embodiment said normalized target distortions are modified ΔD*_{b} to take into account the tonality (both for the dynamic and the steady-state case), whereby for the dynamic case the tonal components are penalized:

$$Δ {{D}^{*}}_{b , Dynamic} = Δ {D}_{b , Dynamic} ( α T + 1 )$$

wherein αε [symbol] , and
wherein for steady-state the tonal components are preserved:

$$Δ {{D}^{*}}_{b , SS} = Δ {D}_{b , SS} ( 1 - T )$$

According to said same embodiment said (frequency dependent) normalized target distortions are mapped to a number (such as thirty-two) of frequency bands of equal importance (i.e. auditory bands) and this is done both for the dynamic and steady-state case, thus:

$$Δ {{D}^{\#}}_{bg , Dynamic} = {max}_{b ∈ bg} Δ {{D}^{*}}_{b , Dynamic}$$

Next the normalized target distortions are constrained to be between zero and a maximum value of unity for both the dynamic and the steady state case, wherein in the following both the dynamic and the steady state case are represented by the symbol θ:

$$Δ {{D}^{\#}}_{tot , θ} = {\sum }_{b} Δ {{D}^{\#}}_{b , θ}$$

Wherein, in the following, according to an embodiment b represents the frequency bands of a gammatone filterbank.

Now if: ΔD^{#}_{tot,θ}<1, then ΔD^{C}_{b,θ} are not constrained to be equal to: ΔD^{#}_{b,θ}.

However, if: ΔD^{#}_{tot,θ}>1 then ΔD^{C}_{b,θ}=ΔD^{#}_{b,θ}/ΔD^{#}_{tot,θ}

Next the normalized, constrained target distortions are scaled to the available budgets Ω_{θ} (representing both Ω_{Dynamic} and Ω_{SS}):

$$Δ {\hat{D}}_{b , θ} = Δ {{{D}^{C}}_{b , θ} ( {10}^{( {Ω}_{θ} / 10 )} - 1 )}^{x}$$

Based hereon the contributions from the dynamic and the steady-state cases are summed whereby we get:

$$Δ {\hat{D}}_{b} = Δ {\hat{D}}_{b , dynamic} + Δ {\hat{D}}_{b , SS}$$

and based hereon we can calculate the band distortions:

$${D}_{b} = 1 + Δ {\hat{D}}_{b}$$

Thus having determined the band distortions, it is e.g. possible to approximate, e.g. the required voice encoding (which in the following may also be denoted vocoding) ΔL_{vocoding,b} to provide said band distortions:

$$Δ {L}_{vocoding , b} ≅ \sqrt{{log}_{2} ( {D}_{b} \cdot {PNSR}_{b} + 1 )} - \sqrt{{log}_{2} ( {PNSR}_{b} + 1 )}$$

It is noted that here a positive vocoding implies a gain reduction for the signal.

However, according to an alternative embodiment the distortion can be applied as a pure increase in probe noise ΔLP_{robe Noise,b}:

$$Δ {L}_{Probe Noise , b} ≅ \sqrt{{log}_{2} ( {D}_{b} )}$$

It is noted that a pure increase in probe noise is less attractive due to potential clipping of the signal and due to missing the benefit from having some gain reduction.

In a further (alternative) embodiment the custom distortions n′(b) are constrained such that a maximum “distortion budget” B is not exceeded, e.g. such that:

$$10 \cdot {Log}_{10} {D}^{′} \leq B$$

The constrained custom distortions n′(b) can then be provided as a probe noise boost (e.g. as determined by the noise boost factor K_{b}(t,f)) and/or be converted to a complete or partial substitution of the hearing loss compensation gain in at least one frequency range or frequency band and/or be converted to vocoding.

1. A method (300) of operating a hearing aid system comprising the steps of:
receiving, by an acoustical-electrical input transducer an acoustical input signal and providing an input transducer output signal;
processing a residual signal to generate a processed residual signal, wherein the residual signal is provided by subtracting a feedback cancellation signal from the input transducer output signal;
generating by an electrical-acoustical output transducer an acoustical output signal based on an output transducer input signal;
generating a probe noise signal with a determined probe noise level;
adding the probe noise signal to the processed residual signal (304) and hereby providing the output transducer input signal;
estimating, by an adaptive feedback estimator, an acoustic feedback path;
receiving, by an adaptive feedback filter, the output transducer input signal and generating the feedback cancellation signal based on the estimated acoustic feedback path;
a) determining (301) as a function of frequency a loop gain, a measure of feedback path change and a measure of tonal components;
b) determining (302) as a function of frequency a total sound quality reduction based on said loop gain, feedback path change measure and measure of tonal components;
c) determining (303) as a function of frequency:
the probe noise level based on said determined total sound quality reduction; and
an attenuation factor; and
d) attenuating (304) the processed residual signal with said attenuation factor.

2. The method according to claim 1, wherein the step of determining as a function of frequency a loop gain comprises the further steps of:
determining the attenuation of the acoustic feedback path;
determining the gain of the hearing aid from input to output; and
determining the loop gain as the product of said determined attenuation of the acoustic feedback path and said determined gain of the hearing aid.

3. The method according to claim 1, wherein the step of determining as a function of frequency a measure of feedback path change comprises the further step of:
determining a frequency dependent statistical estimate of a drift of at least one adaptive feedback cancellation filter characteristic.

4. The method according to claim 1, wherein the step of determining as a function of frequency a measure of tonal components comprises the further steps of:
estimating for a plurality of frequency ranges a minimum and a maximum value of signal power in the input transducer output signal; and
determining the measure of tonal components based on a ratio of the estimated maximum value of the signal power compared to the estimated minimum value of the signal power, wherein the measure of tonal components decreases with the estimated ratio.

5. The method according to claim 1, wherein the step of determining as a function of frequency a measure of tonal components comprises the further steps of:
estimating for a plurality of frequency ranges the signal bandwidth of the input transducer output signal; and
determining the measure of tonal components based on the determined signal bandwidth and the stability of the signal in the main signal path, wherein the measure of tonal components decreases with the determined bandwidth and increases with the stability if the determined bandwidth is below a given threshold.

6. The method according to claim 1, wherein the step of determining as a function of frequency a total sound quality reduction comprises the further steps of:
determining as a function of frequency a first steady-state sound quality reduction as a function of the loop gain, wherein the first steady-state sound quality reduction is monotonically increasing with the loop gain;
determining as a function of frequency a first dynamic sound quality reduction as a function of the measure of feedback path change wherein the first dynamic sound quality reduction is monotonically increasing with the measure of feedback path change; and
determining as a function of frequency the total sound quality reduction based on said first dynamic sound quality reduction and said first steady-state sound quality reduction.

7. The method according to claim 1, wherein the step of determining as a function of frequency a total sound quality reduction comprises the further steps of:
determining a first budget for dynamic sound quality reduction and a second budget for steady-state sound quality reduction each based on at least one of user preference, identified sound environment, a wireless communication signal, a motion sensor output and a default hearing aid setting;
determining as a function of frequency a first dynamic sound quality reduction as a function of the measure of feedback path change wherein the first dynamic sound quality reduction is monotonically increasing with the measure of feedback path change;
determining as a function of frequency a first steady-state sound quality reduction as a function of the loop gain, wherein the first steady-state sound quality reduction is monotonically increasing with the loop gain;
determining as a function of frequency a second dynamic sound quality reduction by allocating the first budget for dynamic sound quality reduction as a function of frequency such that lowering the risk of feedback is prioritized in the frequency ranges having the highest values of the first dynamic sound quality reduction;
determining as a function of frequency a second steady-state sound quality reduction by allocating the second budget for steady-state sound quality reduction as a function of frequency such that lowering the risk of feedback is prioritized in the frequency ranges having the highest values of the first steady-state sound quality reduction, and
determining as a function of frequency the total sound quality reduction as a function of said second dynamic sound quality reduction and said second steady-state sound quality reduction.

8. The method according to claim 6, comprising the further step of
increasing the determined first dynamic sound quality reduction with increasing loop gain above a first threshold value and with increasing measure of tonal components.

9. A method of operating a hearing aid system comprising the steps of:
receiving, by an acoustical-electrical input transducer an acoustical input signal and providing an input transducer output signal;
processing a residual signal to generate a processed residual signal, wherein the residual signal is provided by subtracting a feedback cancellation signal from the input transducer output signal;
generating by an electrical-acoustical output transducer an acoustical output signal based on an output transducer input signal;
estimating, by an adaptive feedback estimator, an acoustic feedback path;
receiving, by an adaptive feedback filter, the output transducer input signal and generating the feedback cancellation signal based on the estimated acoustic feedback path;
determining a target distortion based on a distortion budget, based on a masking level and based on at least one of a loop gain, a measure of a feedback path change and a measure of tonal components;
providing said target distortion based on at least one of:
generating a probe noise signal with a determined probe noise level and frequency distribution;
substituting completely or partially a hearing loss compensation gain; and
preserving the spectral envelope based at least partly on using voice encoding.

10. The method according to claim 9, wherein said distortion budget represents an upper limit for an acceptable sound quality reduction.

11. A computer program product comprising instructions which, when the program is executed by a processor, cause the processor to carry out the method according to claim 1.

12. A hearing aid system adapted to carry out the steps of the method of claim 1.
